(19) United States
(12) Patent Application Publication
(10) Pub. No.: US 2026/0278662 A1
(43) Pub. Date: Sep. 17, 2026

(54) OUTPUT CONTROL METHOD, OUTPUT CONTROL DEVICE, AND RECORDING MEDIUM

(71) Applicant: NEC Corporation, Tokyo (JP)

(72) Inventor: Hiroki ITOU, Tokyo (JP)

(73) Assignee: NEC Corporation, Tokyo (JP)

(21) Appl. No.: 19/532,039

(22) Filed: Feb. 6, 2026

(30) Foreign Application Priority Data
Mar. 12, 2025 (JP) 2025-039352

(51) Int. Cl. G06Q 30/0601

(52) U.S. Cl. CPC G06Q 30/06331; G06Q 30/0641

(57) ABSTRACT

An output control device includes: at least one memory configured to store instructions; and at least one processor configured to execute the instructions to: acquire product identification information for identifying a product in an actual store by an operation of a customer, via a terminal that executes an application program used for product registration in an EC store and the actual store; and output, to the terminal, information browsable in the EC store for the product identified by the product identification information when the product identification information is acquired via the terminal.

This application is based upon and claims the benefit of priority from Japanese Patent Application No. 2025-039352, filed on Mar. 12, 2025, the disclosure of which is incorporated herein in its entirety by reference.

### TECHNICAL FIELD

The present disclosure relates to an output control method and the like.

### BACKGROUND ART

An application program for scanning a product by an operation of a customer in an actual store is known.

An application program may be prepared for an electronic commerce (EC) store.

For example, JP 2021-170153 A describes that, when a mobile terminal reads a code attached to a fabric of a curtain in a made-to-order curtain shop, the mobile terminal accesses a product search page of a curtain purchase web site opened on a web server based on an address printed on the code.

### SUMMARY

By the way, for example, it is desired to utilize the purchasing experience in an EC store for purchasing in an actual store.

An object of the present disclosure is to provide an output control method and the like capable of improving a customer's purchasing experience.

In an output control method according to one aspect of the present disclosure, at least one computer executes processing including:

acquiring product identification information for identifying a product in an actual store by an operation of a customer, via a terminal that executes an application program used for product registration in an EC store and the actual store; and

when the product identification information is acquired via the terminal, outputting, to the terminal, information browsable in the EC store for the product identified by the product identification information.

An output control device according to one aspect of the present disclosure includes:

an acquisition means for acquiring product identification information for identifying a product in an actual store by an operation of a customer, via a terminal that executes an application program used for product registration in an EC store and the actual store; and

an output means for outputting, to the terminal, information browsable in the EC store for the product identified by the product identification information when the product identification information is acquired via the terminal.

A program according to one aspect of the present disclosure is a program for causing at least one computer to execute processing including:

acquiring product identification information for identifying a product in an actual store by an operation of a customer, via a terminal that executes an application program used for product registration in an EC store and the actual store; and

when the product identification information is acquired via the terminal, outputting, to the terminal, information browsable in the EC store for the product identified by the product identification information.

Each of the programs may be stored in a non-transitory recording medium readable by the at least one computer.

### BRIEF DESCRIPTION OF THE DRAWINGS

FIG. 1 is an explanatory diagram illustrating an example of an information processing system including an output control device;

FIG. 2 is a block diagram illustrating a configuration example of the output control device;

FIG. 3 is an explanatory diagram illustrating a screen display example of a terminal for product reading;

FIG. 4 is an explanatory diagram illustrating a screen display example of a comparison result;

FIG. 5 is a flowchart illustrating an operation example of the output control device;

FIG. 6 is a block diagram illustrating a configuration example of an output control device;

FIG. 7 is an explanatory diagram illustrating a screen display example notifying that a user is near a product;

FIG. 8 is a flowchart illustrating an operation example of the output control device; and

FIG. 9 is an explanatory diagram illustrating a hardware configuration example of a computer.

### EXAMPLE EMBODIMENT

Hereinafter, example embodiments of an output control device, an output control method, a program, and a non-transitory recording medium recording the program according to the present disclosure will be described in detail with reference to the drawings. The example embodiments do not limit the disclosed technique.

### First Example Embodiment

In a first example embodiment, an example of a basic function of an output control device will be described in detail with reference to the drawings.

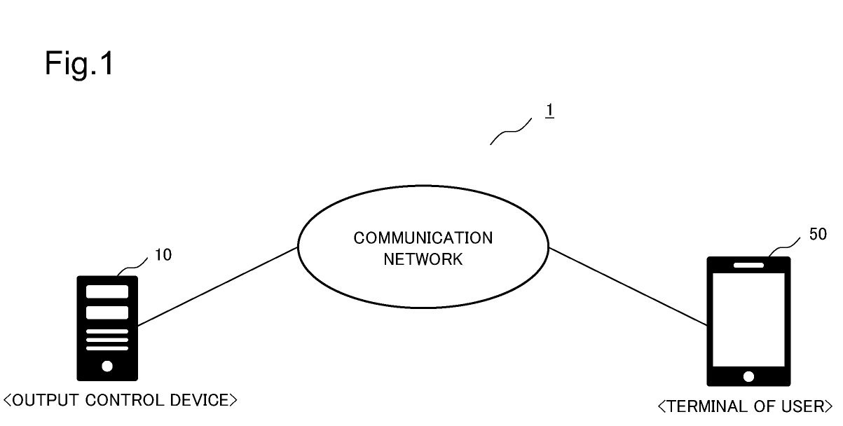

FIG. 1 is an explanatory diagram illustrating an example of an information processing system 1 including the output control device. The information processing system 1 includes, for example, an output control device 10 and a terminal 50.

The output control device 10 is connected to the terminal 50 via a communication network. The type and configuration of the communication network are not particularly limited.

The terminal 50 may be, for example, a terminal of a customer or a terminal that can be lent to a customer at a store. For example, an application program used for product registration in an EC store and an actual store is installed in the terminal 50 in advance. For example, the terminal 50 executes the application program. For example, the application program can output information from the output control device 10 and can transmit information to the output control device 10. For example, in a case where the terminal 50 is the terminal 50 that can be lent to a customer at a store, the terminal 50 can be used similarly to the terminal 50 of the customer when the customer logs in to an application or the like. The application program may have a function of being able to browse an EC website as an EC store.

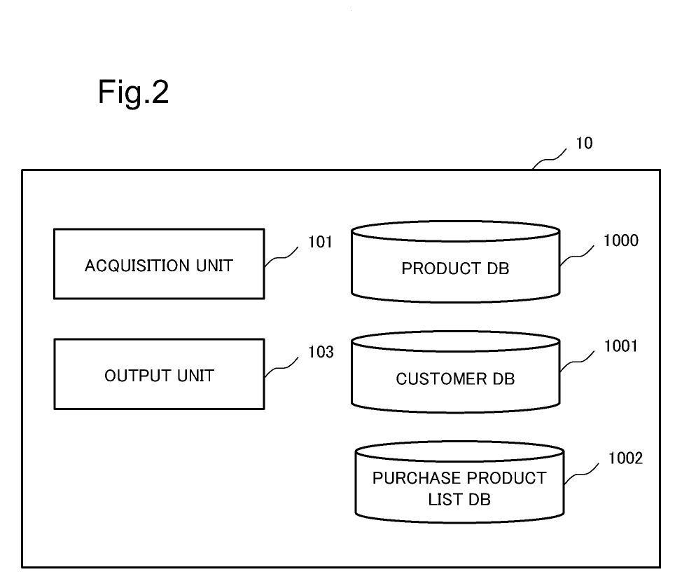

FIG. 2 is a block diagram illustrating a configuration example of the output control device 10. The output control device 10 includes an acquisition unit 101 and an output unit 103. Each functional unit appropriately stores various results, intermediate results, and the like in a storage device or the like, and appropriately reads various information from the storage device. The output control device 10 includes a product database (DB) 1000, a customer DB 1001, and a purchase product list DB 1002.

The product DB 1000 stores information regarding products handled in an EC store and an actual store. Specifically, the product DB 1000 stores, for example, the information regarding products, on a product-by-product basis. The information regarding products is, for example, information such as a product identifier (ID), a product name, a product category, a product price, and a characteristic of the product. The product ID is product identification information for identifying the product. The product ID is not particularly limited. The product ID is, for example, a code for the product (hereinafter, referred to as a product code). More specifically, the product ID may be, for example, a product code of at least one of a Japanese Article Number (JAN) code, a European Article Number (EAN) code, or a Universal Product Code (UPC). Alternatively, the product ID may be a product name. The product category is not particularly limited. For example, the product category may be a large category such as food or stationery. The product category may be a small category such as confectionery, meat, or vegetables. The product category may be hierarchized into a plurality of categories such as a large category, a medium category, and a small category.

The product price is a price of a product. As the product price, for example, there may be a product price in an EC store and a product price in an actual store.

The characteristic of the product is not particularly limited. The characteristic of the product may be a best-before date, a use-by date, a manufacturer, or the like.

The information regarding products may include information for identifying the product, in addition to the product ID information. For example, the information regarding products may include product image data, feature amount information obtained from the product image data, and the like.

The information regarding products includes information that can be browsed in the EC store. The information browsable in the EC store may be information such as reviews in the EC store. The information browsable in the EC store may include information such as image data of a product imaged by the customer. The information browsable in the EC store may be link information of a post of a social networking service (SNS) related to the product or a post of the SNS related to the product. The application program may have a function of being able to browse a website of the EC as the EC store. In such a case, the information browsable in the EC store may be information browsable on an EC website.

The product DB 1000 may not include a part of the above-described information regarding the product. The product DB 1000 may include information other than the above-described information regarding the product.

The customer DB 1001 stores information regarding a customer, on a customer-by-customer basis. The information regarding the customer is, for example, information of at least one of a customer ID, a name of the customer, a gender of the customer, an age or an age group of the customer, and a notification destination of the customer. The customer ID is, for example, an identifier for uniquely identifying a customer. The type of the customer ID is not particularly limited. The customer ID may be represented by a customer number. The notification destination is a notification destination such as an e-mail address or a telephone number. The customer DB 1001 may further store, on a customer-by-customer basis, information such as a password, a past purchase history, a browsing history of products in the EC store, a product wish list for products in the EC store, and points. The product wish list is, for example, a favorite list.

The purchase product list DB 1002 stores the latest purchase product list for which payment has not been completed, on a transaction-by-transaction or customer-by-customer basis. The purchase product list stores, for example, information for identifying a transaction or a customer, product identification information for identifying a product that the customer intends to purchase, information on a purchase quantity of the product, and a type of a store of the product in association with each other, on a transaction-by-transaction or customer-by-customer basis. The information for identifying the transaction is not particularly limited as long as the information can uniquely identify the transaction, for example. The information for identifying the customer is not particularly limited as long as the information can uniquely identify the customer, for example. For example, the product identification information includes a product ID. As a result, the purchase product list is associated with the product DB 1000 by the product ID. Further, the type of store indicates, for each product, whether the product is registered in the EC store or the product is registered in the actual store.

Therefore, by referring to the purchase product list, the output control device 10 can obtain the product price, the name of the product, and the like from the product DB 1000 by means of the product ID registered in the purchase product list. The purchase product list may store a tax-included price of the product as the information regarding products based on the product price. The purchase product list may further include information on a total purchase price and information on a total purchase quantity, on a customer-by-customer basis.

The acquisition unit 101 acquires the product identification information for identifying the product in the actual store via the terminal 50 that executes the application program used for product registration in the EC store and the actual store.

The acquisition unit 101 acquires the product identification information for identifying the product to be purchased by the customer in the actual store by the operation of the customer. The acquisition unit 101 acquires the product identification information for product registration. The product identification information acquired here may be the product ID information. The acquired product identification information may be product image data or feature amount information obtained from the product image data. The acquired product identification information is not limited thereto. The acquired product identification information may be any information as long as the product identification information can uniquely identify the product to be purchased by the customer. As a method for acquiring the product identification information, there are various examples such as reading of a product code which is information of the product ID, identification by an image, and reading of a tag. The acquisition method is not particularly limited.

As a processing example in which the acquisition unit 101 acquires the product identification information, the acquisition unit 101 acquires the product identification information by, for example, reading the product code via a reading device. The reading device is not particularly limited. The reading device may be, for example, an imaging device included in the terminal 50. Examples of the product code include the JAN code described above. The product code is represented by, for example, a number, a character, or a combination thereof. The product code may be indicated by a one-dimensional code such as a barcode, a two-dimensional code, or the like.

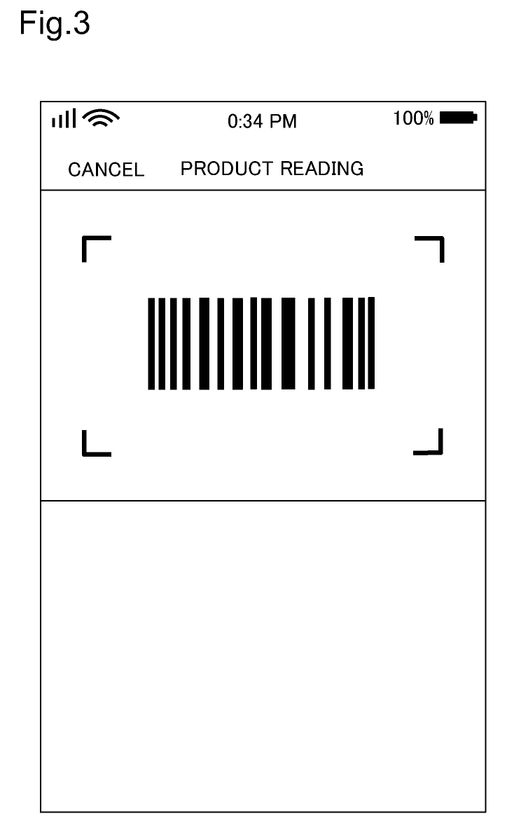

FIG. 3 is an explanatory diagram illustrating a screen display example of the terminal 50 for product reading. For example, in FIG. 3, the output unit 103 may display a frame for reading the product code. Then, the acquisition unit 101 acquires the product identification information by imaging the product code included in the frame by the imaging device included in the terminal 50.

As another processing example in which the acquisition unit 101 acquires the product identification information, for example, the acquisition unit 101 may acquire the product identification information by identifying the product from the image of the product captured by the imaging device included in the terminal 50.

As another processing example in which the acquisition unit 101 acquires the product identification information, the acquisition unit 101 identifies a product that reads an image of a product or an image of a picture of a product captured in advance via the imaging device. Thus, the acquisition unit 101 acquires the product identification information.

As another processing example in which the acquisition unit 101 acquires the product identification information, the acquisition unit 101 may acquire, via a reading device, the product identification information by reading a tag to which a radio frequency identifier (RFID) is attached. When the RFID is used, the reading device is an RFID reader.

When the product identification information is acquired via the terminal 50, the output unit 103 outputs information browsable in the EC store regarding the product identified by the product identification information to the terminal 50. The output method is not particularly limited, and examples thereof include screen display and voice output. For example, the output method may be push notification to an application program or the like. Specifically, for example, the output unit 103 acquires information browsable in the EC store associated with the product identification information from the product DB 1000. Then, the output unit 103 outputs information browsable in the EC store to the terminal 50.

When the product identification information is acquired, the output unit 103 outputs, to the terminal 50, information regarding at least one of a product registered in the purchase product list in the EC store, a product registered in the product wish list in the EC store, and a product browsed by a customer specified on the basis of a browsing history of products in the EC store. The information regarding the product output here may be, for example, information regarding any product included in the product DB 1000. In a case where the output information regarding the product is information regarding the product registered in the product wish list in the EC store, the output information may be the number of products registered in the product wish list. This makes it possible to remind the customer of a product or the like that the customer is interested in.

More specifically, for example, even though a product is already registered in an EC store, the same product may be registered in the store. For example, when the product identification information is acquired, the output unit 103 outputs, to the terminal 50, information regarding a product indicating that the type of the store of the product, among the products registered in the purchase product list of the customer registered in the purchase product list DB 1002, is an EC store.

In some cases, the product registered in the product wish list in the EC store is different from the product registered in the store. For example, there is a case where a customer forgets a product registered in a product wish list in an EC store. For example, when the product identification information is acquired, the output unit 103 may output information regarding the product registered in the product wish list of the customer included in the customer DB 1001.

In some cases, the product browsed by the customer in the EC store is different from the product registered in the store. Alternatively, there is a case where a customer forgets to purchase a product browsed by the customer at the EC store. For example, when the product identification information is acquired, the output unit 103 may output information regarding the product registered in the product wish list of the customer included in the customer DB 1001. Specifically, for example, when the product identification information is acquired, the output unit 103 may specify a product browsed by the customer on the basis of a browsing history of products in an EC store included in the customer DB 1001, and output information regarding the specified product. The product browsed by the customer based on the browsing history may be a product frequently browsed by the customer. The product frequently browsed by the customer may be a product browsed a predetermined number of times or more, a product browsed for a predetermined time or more, or a combination thereof. The predetermined number of times and the predetermined time may be specified by a customer, or may be specified by an administrator of at least one of an EC store or an actual store.

For example, since the product is similar to the product that the customer has frequently browsed, the customer may erroneously register the product. Alternatively, there is a case where the customer has registered the product without sufficient examination. Therefore, in a case where the product similar to the product identified by the product identification information is at least one of a product registered in the purchase product list in the EC store, a product registered in the product wish list in the EC store, and a product that has been frequently checked on the basis of a browsing history in the EC store, the output unit 103 outputs, to the terminal 50, a comparison result between the product identified by the product identification information and the similar product. Here, the product similar to the product registered in the store may be a product having the same small category included in the product DB 1000 as the product registered in the store. A method of specifying the product registered in the purchase product list in the EC store, the product registered in the product wish list in the EC store, and the product that has been frequently checked on the basis of the browsing history in the EC store is as described above.

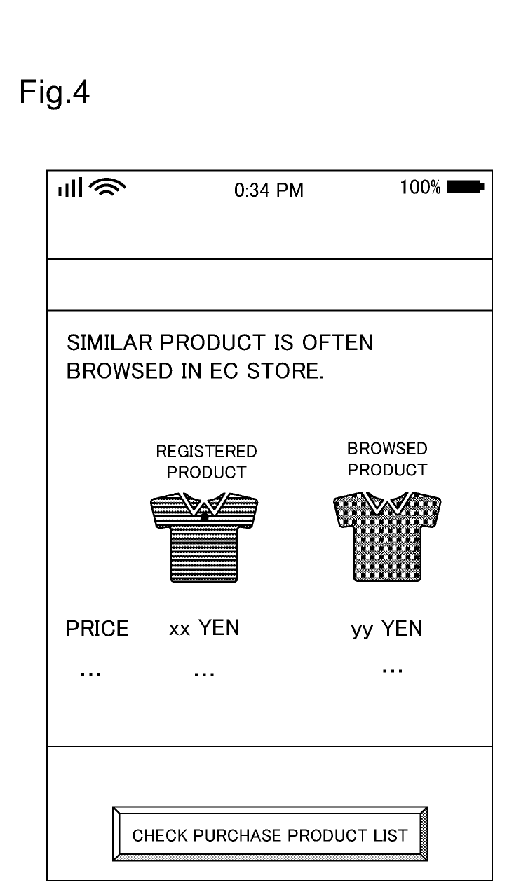

FIG. 4 is an explanatory diagram illustrating a screen display example of a comparison result. A product identified by the product identification information is similar to a product browsed by a customer specified on the basis of a browsing history in an EC store. Therefore, the output unit 103 outputs, to the terminal 50, a comparison result between the product identified by the product identification information and the product browsed by the customer specified on the basis of the browsing history in the EC store.

In FIG. 4, images of registered products and products browsed in an EC store are displayed in a comparable manner. In FIG. 4, the price of the registered product and the price of the browsed product are displayed in a comparable manner.

The content of the comparison is not limited to the image and the price. For example, the content of the comparison may be different according to the product category. For example, if the product is clothes, a comparison result of color, size feeling, pattern, type of fabric, and the like may be output. For example, in a case where the product is food, a comparison result such as flavor and weight may be output.

Although FIG. 4 illustrates the “registered products”, the comparison result may be displayed before registration. For example, a registration button or the like of the product for which the product identification information has been acquired may be provided on the screen of the comparison result, and the product may be registered after the customer confirms the comparison result. The output unit 103 may output the position information of the browsed product in the actual store. For example, the output unit 103 may superimpose and display the position information of the browsed product in the actual store on the map of the actual store. The similar product may be a plurality of similar products.

### Flowchart

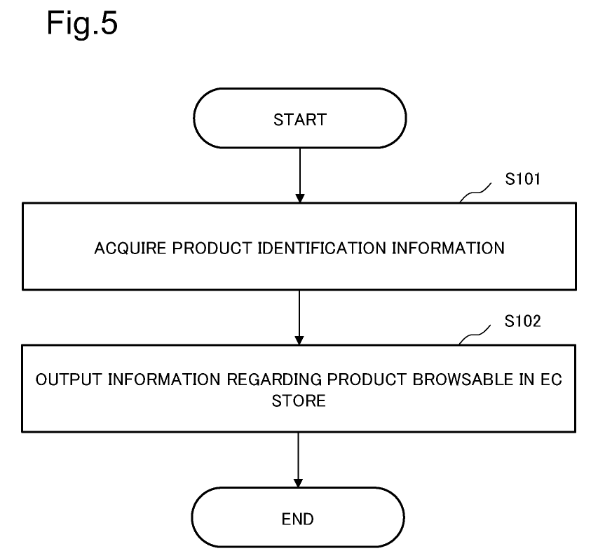

FIG. 5 is a flowchart illustrating an operation example of the output control device 10. First, the acquisition unit 101 acquires the product identification information in the actual store by the operation of the customer (step S101). Next, the output unit 103 outputs information regarding the product browsable in the EC store for the product identified by the product identification information (step S102). In step S102, in a case where the product similar to the product identified by the product identification information is at least one of the product registered in the purchase product list in the EC store, the product registered in the product wish list in the EC store, and the product that has been frequently checked on the basis of the browsing history in the EC store, the output unit 103 outputs, to the terminal 50, a comparison result between the product identified by the product identification information and the similar product. The output control device 10 ends the series of processes illustrated in FIG. 5.

As described above, in the first example embodiment, the output control device 10 acquires the product identification information in the actual store by the operation of the customer via the terminal 50 that executes the application program used for product registration in the EC store and the actual store. Next, the output control device 10 outputs information regarding the product browsable in the EC store for the product identified by the product identification information. As a result, by providing the information obtained in the EC store, it is possible to provide more abundant information to the customer. For example, the output control device 10 can support a customer's product selection or purchase decision, by providing information used in the EC store when a product is scanned in the actual store. Therefore, the purchasing experience can be improved. One application program can be used in both an EC store and an actual store, and information can be unified. Therefore, it is possible to improve the convenience.

When the product identification information is acquired, the output control device 10 outputs, to the terminal 50, information regarding at least one of a product registered in the purchase product list in the EC store, a product registered in the product wish list in the EC store, and a product browsed by the customer specified on the basis of the browsing history in the EC store.

In a case where the product similar to the product identified by the acquired product identification information is at least one of the product registered in the purchase product list in the EC store, the product registered in the product wish list in the EC store, and the product browsed by the customer specified on the basis of the browsing history in the EC store, the output control device 10 outputs, to the terminal 50, a comparison result between the product identified by the acquired product identification information and the similar product. It is possible to prevent a purchase error. It is possible to cause a customer to purchase a more desired product.

The output control device 10 outputs the comparison result to the terminal 50 before the product identified by the acquired product identification information is registered in the purchase product list in the actual store. As a result, it is possible to check the product that the customer wants to buy before the product registration is performed.

### Second Example Embodiment

A second example embodiment will be described in detail with reference to the drawings. In the second example embodiment, an example in which an output control device 20 specifies location information of a terminal 50 and causes the terminal 50 to display various types of information by using the location information of the terminal 50 will be described. In the second example embodiment, a series of processing examples from product registration to payment will be described together. Hereinafter, the description of content that is duplicate of the description above will be omitted to the extent that description of the second example embodiment is not unclear.

The information processing system including the output control device 20 has an additional function described below based on the configuration of the information processing system 1 including the output control device 10 illustrated in FIG. 1.

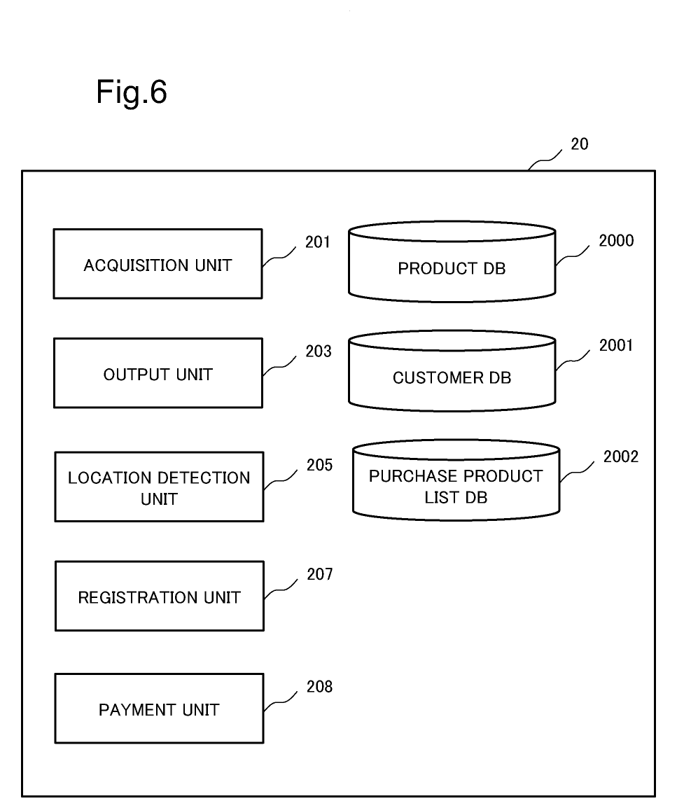

FIG. 6 is a block diagram illustrating a configuration example of the output control device 20. The output control device 20 includes an acquisition unit 201, an output unit 203, a location specifying unit 205, a registration unit 207, and a payment unit 208.

The acquisition unit 201 has the function of the acquisition unit 101 illustrated in FIG. 2 as a basic function. The output unit 203 has the function of the output unit 103 illustrated in FIG. 2 as a basic function. Regarding the acquisition unit 201 and the output unit 203, detailed description of the same processing as the processing described in the first example embodiment will be omitted.

The output control device 20 includes a product DB 2000, a customer DB 2001, and a purchase product list DB 2002. The customer DB 2001 and the purchase product list DB 2002 may be the same as the customer DB 1001 and the purchase product list DB 1002 described in the first example embodiment.

For example, the product DB 2000 may further include shelf allocation information in the information described in the product DB 1000 described in the first example embodiment. Specifically, for example, the product DB 2000 may further include information regarding a position where a product is displayed, on a product-by-product basis. For example, the information regarding the position where the product is displayed may be information indicating a shelf on which the product is displayed, a stage of the shelf, the number of faces on the stage, the position of the row, and the like.

The registration unit 207 registers the acquired product identification information in the purchase product list relevant to the customer included in the purchase product list DB 2002. The registration by the registration unit 207 may use an existing technology, and thus detailed description thereof is omitted. The registration unit 207 may register the product according to the operation of the customer after the output unit 203 outputs the information browsable in the EC. Thus, timing of product registration and timing of outputting various types of information by the output unit 203 are not particularly limited.

When the product registration is performed, the output unit 203 may output the purchase product list to the terminal 50. Specifically, for example, in addition to the output of a general list including, such as, a total amount, a total number of products, and a name, price, and a quantity of each product, the output unit 203 may output information indicating whether each product is registered at an EC store or registered at an actual store.

The location specifying unit 205 specifies location information of the terminal 50 in the actual store. The location specifying unit 205 may specify the location information of the terminal 50 in the actual store by wireless communication. The wireless communication is not particularly limited, and examples thereof include ultra-wideband wireless communication, a beacon, Wi-Fi (registered trademark), and Bluetooth (registered trademark). As an example of using the ultra-wideband wireless communication, the location specifying unit 205 may specify the location information of the terminal 50 in the actual store, by means of communication, with the terminal 50, of communication devices installed at various locations in the actual store by the ultra-wideband wireless communication. As an example of using a beacon, the location specifying unit 205 can specify the location information of the terminal 50, by means of communication, with the terminal 50, of beacon devices installed at various locations in the actual store. A method of specifying the location information of the terminal 50 is not particularly limited to these examples.

For example, the location specifying unit 205 may specify which one of a plurality of areas in an actual store the user is in or the user is near. For example, an area may be set for each product category. An exit area, a cashier area, and the like may be set. As a method by which the location specifying unit 205 specifies the area, the above-described communication method or the like may be used.

For example, a customer may wish to check an actual product for a product already registered in a purchase product list in an EC store, a product registered in a product wish list in an EC store, a product browsed by a customer specified on the basis of a browsing history in an EC store, and the like. The store management side may also want the customer to check the actual product. Therefore, in a case where, on the basis of the shelf allocation information in the actual store and the location information of the terminal 50, the terminal 50 approaches at least one of the product registered in the purchase product list in the EC store, the product registered in the product wish list in the EC store, and the product browsed by the customer specified on the basis of the browsing history in the EC store, the output unit 203 outputs information regarding one of the products to the terminal 50. The shelf allocation information in the actual store is included in the product DB 2000 as described above. Here, at least one of the products is referred to as a specific product.

Specifically, for example, the output unit 203 outputs information regarding a specific product on the basis of position information indicating a position where the specific product is displayed in an actual store and location information of the terminal 50 specified by the location specifying unit 205. More specifically, for example, in a case where the distance between the position where the specific product is displayed in the actual store and the location of the terminal 50 is within a predetermined distance, the output unit 203 outputs information regarding the specific product. The predetermined distance may be appropriately set to 1 meter, 2 meters, or the like. Alternatively, for example, the output unit 203 may output information regarding a specific product, as long as an area in an actual store related to the category of the specific product is the same as an area in which the terminal 50 is located. As a result, it is possible to detect that the terminal 50 has approached a specific product.

Specifically, taking the product registered in the purchase product list in the EC store as an example, the position information of the product indicating that the type of the store of the product is the EC store among the products registered in the purchase product list of the customer registered in the purchase product list DB 2002 is specified from the product DB 2000. Then, the output unit 203 outputs information regarding the product registered in the purchase product list in the EC store on the basis of the position information indicating the position where the product registered in the purchase product list in the EC store is displayed in the actual store and the location information of the terminal 50.

The output unit 203 may output, to the terminal 50, that a user is near the product as the information regarding the specific product. The output unit 203 may output, to the terminal 50, that the user is near the product together with the information regarding the product included in the product DB 2000, as the information regarding the specific product.

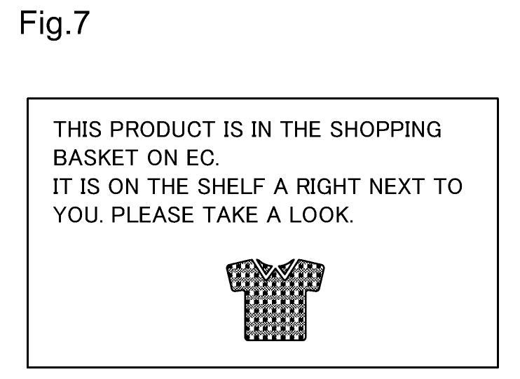

FIG. 7 is an explanatory diagram illustrating a screen display example notifying that the user is near the product. The purchase product list is referred to as a shopping basket, and for example, the output unit 203 displays, on the terminal 50, the fact that the user is near the product registered in the shopping basket at the EC store and an image of the product. The output unit 203 also displays shelf information of the product on the terminal 50.

In a case where the terminal 50 approaches the cashier area or the exit area in the actual store, the output unit 203 outputs, to the terminal 50, information regarding at least one of the product registered in the purchase product list in the EC store, the product registered in the product wish list in the EC store, and the product browsed by the customer specified on the basis of the browsing history in the EC store. It is possible to remind the customer of each product before making a payment or before the customer comes home. For example, the output unit 203 may output “Are you sure that you do not want to check the product?”, “The product browsed at the EC store is on the shelf A”, and the like to the terminal 50.

The payment unit 208 makes a payment for the product registered in the purchase product list in the EC store and the actual store via the terminal 50. The payment method is not particularly limited as long as electronic payment such as credit card payment or code payment is performed. As a result, it is possible to collectively purchase the products registered in the purchase product list in the EC store and the actual store by centrally managing the purchase product list used in the EC store and the actual store.

The output unit 203 outputs the checkout information based on the information regarding the product registered in the purchase product list in the EC store and the actual store such that the checkout device installed in the actual store can read the checkout information. The checkout information may include, for example, information that allows the checkout device to access the purchase product list of the customer in the purchase product list DB 2002. Alternatively, the checkout information may include information such as a total amount calculated on the basis of the purchase product list. The checkout information may be represented by a code such as a one-dimensional code or a two-dimensional code. For example, the output unit 203 displays a code representing the checkout information on the terminal 50. The checkout device can make a payment by reading the code displayed on the terminal 50. Then, the payment unit 208 makes a payment for the product registered in the purchase product list in the EC store and the actual store via the terminal 50.

### Flowchart

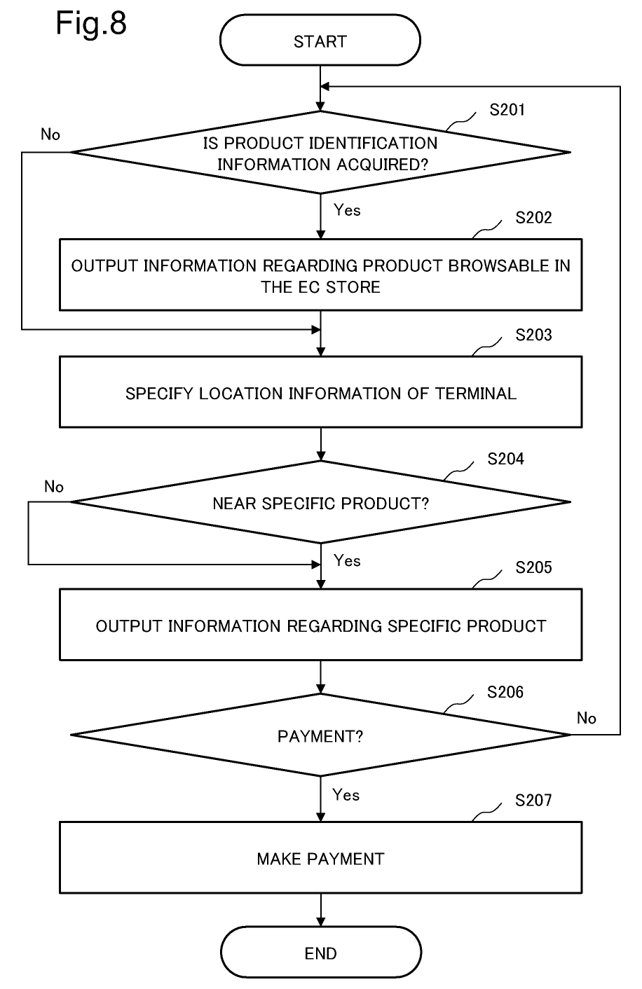

FIG. 8 is a flowchart illustrating an operation example of the output control device 20. The acquisition unit 201 determines whether the product identification information has been acquired (step S201). In a case where the product identification information has been acquired (Step S201: Yes), the output unit 203 outputs information regarding a product browsable in the EC store for the product identified by the product identification information (Step S202). When it is determined that the product identification information has not been acquired (Step S201: No), the output control device 20 proceeds to Step S203.

The location specifying unit 205 specifies the location information of the terminal 50 in the actual store (step S203). Then, the output unit 203 determines whether the terminal 50 is near the specific product on the basis of the location information of the terminal 50 specified by the location specifying unit 205 and the shelf allocation information in the actual store (step S204).

In a case where it is determined that the terminal 50 is near the specific product (Step S204: Yes), the output control device 20 outputs information regarding the specific product (Step S205). When it is determined that the terminal 50 is not near the specific product (step S204: No), the output control device 20 proceeds to step S206.

The payment unit 208 determines whether a payment instruction has been received (step S206). For example, the payment instruction may be a fact that a payment button or the like is pressed. When it is determined that the payment instruction has not been received (step S206: No), the output control device 20 returns to step S201. When it is determined that the payment instruction has been received (step S206: Yes), the payment unit 208 makes a payment for the product registered in the purchased product list at the EC store and the actual store via the terminal 50 (step S207). Then, the output control device 20 ends a series of processes illustrated in FIG. 8. The order of the steps is not particularly limited, and may be appropriately changed.

As described above, in the second example embodiment, in a case where, on the basis of the shelf allocation information in the actual store and the location information of the terminal 50, the terminal 50 approaches at least one of the product registered in the purchase product list in the EC store, the product registered in the product wish list in the EC store, and the product browsed by the customer specified on the basis of the browsing history in the EC store, the output control device 20 outputs the information regarding one of the products to the terminal 50. For example, a customer can check an actual product for a product already registered in a purchase product list in an EC store, a product registered in a product wish list in an EC store, a product browsed by a customer specified on the basis of a browsing history in an EC store, and the like. Therefore, it is possible to improve the purchasing experience.

When approaching the cashier area or exit area, it is expected that the customer will likely leave the store. In a case where the terminal 50 approaches the cashier area or the exit area in the actual store, the output control device 20 outputs, to the terminal 50, information regarding at least one of the product registered in the purchase product list in the EC store, the product registered in the product wish list in the EC store, and the product browsed by the customer specified on the basis of the browsing history in the EC store. It is possible to have the customer check the actual product before leaving the store or to remind the customer not to forget to buy the product. Therefore, it is possible to improve the purchasing experience.

Thus, the description of each example embodiment ends. The example embodiments are not limited to the examples described above, and various modifications can be made. Modified examples will be described hereinafter.

### First Modified Example

In the second example embodiment, an example in which the location of the customer is specified by specifying the location information of the terminal 50 has been described. For example, the location specifying unit 205 may specify the location information of the customer from the image captured by each imaging device installed in the store. For example, a customer may be identified by performing authentication or the like at the time of entrance, and the location specifying unit 205 may track a traffic line of the customer. In a case where, on the basis of the shelf allocation information in the actual store and the location information of the customer, the customer approaches at least one of the product registered in the purchase product list in the EC store, the product registered in the product wish list in the EC store, and the product browsed by the customer specified on the basis of the browsing history in the EC store, the output unit 203 outputs information regarding one of the products to the terminal 50.

### Second Modified Example

For example, in a case where the customer wants to check a product browsed at the EC store, the customer may specify the product. Then, the output unit 203 may output information regarding the product specified by the customer in the EC store to the terminal 50 in the actual store. For example, timing of an output by the output unit 203 may be timing at which the product identification information for identifying any product is acquired, may be a case where the terminal 50 or the customer approaches the product specified by the customer in the actual store, or may be a case where the terminal or the customer approaches or is in the cashier area or the exit area.

### Third Modified Example

In the application program used for product registration in the EC store and the actual store, a mode for performing product registration in the actual store may be different from a mode for performing product registration in the EC store. The product registration in the actual store and the product registration in the EC store may be switchable according to the mode received by the operation of the customer on the terminal 50.

### Fourth Modified Example

In each example embodiment, an example has been described in which the application program used for product registration is installed in advance in the EC store and the actual store, and the terminal 50 executes the application program. That is, an example in which the application program is a native application has been described. For example, the terminal 50 may be able to access an application program used for product registration in an EC store and an actual store via a web browser. Being accessible via the web browser means using a web application or the like.

The description of the modified examples is ended. The example embodiments may be appropriately combined. There is no particular limitation on how example embodiments are combined with each other. In addition, the example embodiments and the modified examples may be appropriately combined. How the embodiments and examples are combined is not particularly limited.

The configurations of the output control devices 10 and 20 are not particularly limited. For example, the functional units of the output control device 10 or 20 may be implemented by one device. Alternatively, for example, the functional units of the output control device 10 or 20 may be implemented by different devices for different databases, and may be configured as a system. For example, the functional units of the output control device 10 or 20 may be configured by a plurality of servers and implemented as a distributed system. For example, a system including a database server including databases and a server including the functional units of the output control device 10 or 20 may be implemented. A system including a server including some of the functional units of the output control device 10 or 20 and a server including some of the others of the functional units of the output control device 10 or 20 may be implemented. The number of servers is not particularly limited. The terminal 50 may have at least some of the functional units of the output control device 10 or 20.

The various DBs and information are examples, and may further include other information or may not include some information. The various DBs may be further divided into a plurality of DBs, and the configuration of the DBs is not particularly limited. For example, the purchase product list DB does not include the type of store, and may be divided into a purchase product list DB for an actual store and a purchase product list DB for an EC store, and may be associated with a customer ID or the like.

The user interface in each example embodiment is an example, and various modifications are possible. The configurations of the output control devices 10 and 20 are not particularly limited.

### Hardware Configuration Example of Computer

Next, a description will be given of a hardware configuration example in a case where each of the devices such as the output control devices 10 and 20 and the terminal 50 is implemented by a computer.

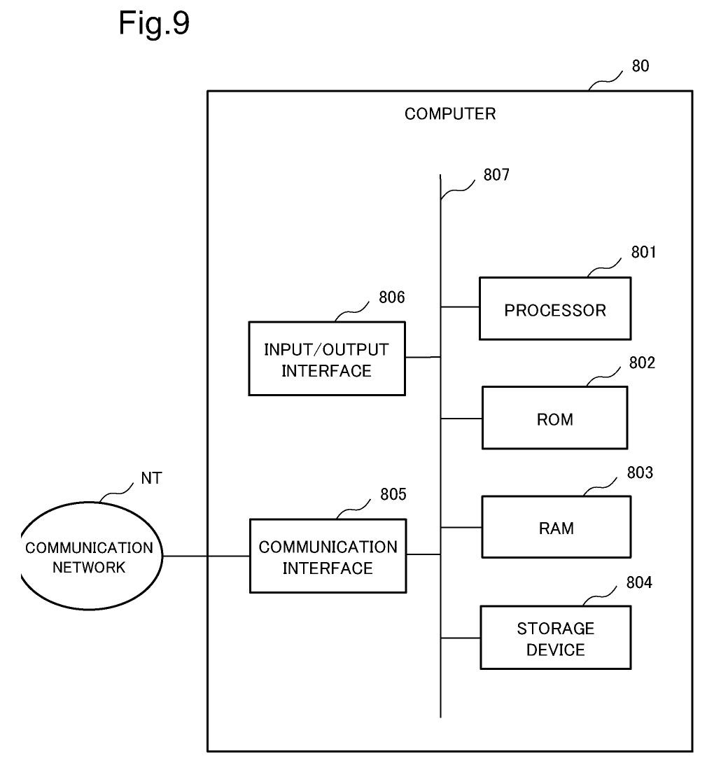

FIG. 9 is an explanatory diagram illustrating a hardware configuration example of a computer. For example, some or all of the devices can be implemented by using any combination of a computer 80 and a program as illustrated in FIG. 9.

The computer 80 includes, for example, a processor 801, a read only memory (ROM) 802, a random access memory (RAM) 803, and a storage device 804. The computer 80 also includes a communication interface 805 and an input/output interface 806. The constituents are connected to each other via a bus 807, for example. The number of constituents is not particularly limited, and one or more constituents are provided.

The processor 801 controls the entire computer 80. As the processor 801, for example, a central processing unit (CPU), a digital signal processor (DSP), a graphics processing unit (GPU), a physics processing unit (PPU), a tensor processing unit (TPU), a quantum processor, or a combination thereof, or the like can be used and is not particularly limited. The processor 801 may be a single-core processor or a multi-core processor.

The computer 80 includes the ROM 802, the RAM 803, the storage device 804, and the like. Examples of the storage device 804 include a semiconductor memory such as a flash memory, a hard disk drive (HDD), a solid state drive (SSD), an optical disk, or the like. These may be used alone or in combination of two or more. For example, the storage device 804 stores an Operating System (OS) program, an application program, a program according to each example embodiment, and the like. Alternatively, the ROM 802 stores an application program, a program according to the example embodiments, and the like. The RAM 803 is used as a work area for the processor 801.

The processor 801 loads a program stored in the storage device 804, the ROM 802, or the like. The processor 801 executes each process coded in the program. The processor 801 may download various programs via a communication network NT. The processor 801 functions as a part or the whole of the computer 80. The processor 801 may execute the processes or instructions in the flowcharts illustrated in the drawings, based on the program.

The communication interface 805 is connected to the communication network NT such as a local area network (LAN) or a wide area network (WAN) through a wireless or wired communication line. The communication network NT may be constituted by a plurality of communication networks NT. As a result, the computer 80 is connected to an external device or an external computer 80 via the communication network NT. The communication interface 805 takes control of an interface between the communication network NT and the inside of the computer 80. The communication interface 805 controls input and output of data from the external device or the external computer 80.

The input/output interface 806 is connected to at least any one of an input device, an output device, and an input/output device. A method of the connection may be wireless or wired. Examples of the input device include a keyboard, a mouse, and a microphone. Examples of the output device include a display device, a lighting device (such as a lamp), and a sound output device that outputs a sound. Examples of the input/output device include a touch panel display. The input device, the output device, the input/output device, and the like may be built in the computer 80 or may be externally attached to the computer 80. That is, for example, the computer 80 may include an input device such as a keyboard or a mouse. The computer 80 may include an output device such as a display. The computer 80 may include each of an input device, an output device, and an input/output device.

The hardware configuration of the computer 80 is an example. The computer 80 may have some components shown in FIG. 9. The computer 80 may have components other than those illustrated in FIG. 9. For example, the computer 80 may include a drive device. The processor 801 may read a program or data stored in a recording medium attached to a drive device or the like into the RAM 803. Examples of the non-transitory tangible recording medium include an optical disk, a flexible disk, a magneto-optical disk, and a universal serial bus (USB) memory.

The computer 80 may include various sensors (not illustrated). The type of the sensor is not particularly limited. The computer 80 may include an imaging device capable of capturing images and videos.

Thus, the description of the hardware configuration of each device has ended. A method for implementing each device has various modified examples. For example, each device may be implemented by any combination of a computer and a program different for each component. A plurality of components included in each device may be implemented by any combination of one computer and a program.

Some or all of components of each device may be implemented by an application specific circuit. Some or all of the components of each device may be implemented by a general-purpose circuit such as a field programmable gate array (FPGA). Some or all of the components of each device may be implemented by a combination of an application specific circuit, a general-purpose circuit, and the like. The circuits may be a single integrated circuit. Alternatively, the circuits may be divided into a plurality of integrated circuits. The plurality of integrated circuits may be configured by being connected via a bus or the like.

In a case where some or all of the components of each device are implemented by a plurality of computers, circuits, and the like, the plurality of computers, circuits, and the like may be disposed in a centralized manner or in a distributed manner.

The output control method described in each example embodiment may be implemented by being executed by a computer such as the output control devices 10 or 20.

Each program described in each example embodiment is recorded in a computer-readable recording medium such as an HDD, an SSD, a flexible disk, an optical disk, a magneto-optical disk, or a USB memory. Each program is read from the recording medium by the computer to be executed. Each program may be distributed via the communication network NT.

Each component of the output control devices 10 and 20 described above may be implemented by dedicated hardware, such as a computer.

Alternatively, the components may be implemented by software. Alternatively, the components may be implemented by a combination of hardware and software.

While the present disclosure has been particularly shown and described with reference to example embodiments thereof, the present disclosure is not limited to these example embodiments. The configurations and details of the present disclosure may include example embodiments to which various changes that can be grasped by those skilled in the art within the scope of the present disclosure are applied. The present disclosure may include example embodiments in which the matters described in the present specification are appropriately combined or replaced, as necessary. For example, the matters described with a specific example embodiment can be applied to other example embodiments as long as no contradiction occurs. For example, although a plurality of operations is described in order in the form of a flowchart, the described order does not limit the order in which the plurality of operations is executed. Thus, when each example embodiment is carried out, the order of the plurality of operations can be changed within a range that does not interfere with the content.

Some or all of the example embodiments described above may also be described as Supplementary Notes below. However, some or all of the example embodiments described above are not limited to the following.

### Supplementary Note 1

An output control method in which at least one computer executes processing comprising:

acquiring product identification information for identifying a product in an actual store by an operation of a customer, via a terminal that executes an application program used for product registration in an

EC store and the actual store; and

when the product identification information is acquired via the terminal, outputting, to the terminal, information browsable in the EC store for the product identified by the product identification information.

### Supplementary Note 2

The output control method according to Supplementary Note 1, in which

in the processing of outputting, when the product identification information is acquired, information regarding at least one product of a product registered in a purchase product list in the EC store, a product registered in a product wish list in the EC store, and a product browsed by the customer specified on the basis of a browsing history in the EC store is output to the terminal.

### Supplementary Note 3

The output control method according to Supplementary Note 2, in which

in the processing of outputting, in a case where a product similar to the product identified by the product identification information is at least one of a product registered in a purchase product list in the EC store, a product registered in a product wish list in the EC store, and a product browsed by the customer specified on the basis of a browsing history in the EC store, a comparison result between the product identified by the product identification information and the similar product is output to the terminal.

### Supplementary Note 4

The output control method according to Supplementary Note 3, in which

in the processing of outputting, the comparison result is output to the terminal before the product identified by the acquired product identification information is registered in the purchase product list in the actual store.

### Supplementary Note 5

The output control method according to any one of Supplementary Notes 1 to 4, in which

in the processing of outputting, in a case where, on the basis of the shelf allocation information in the actual store and the location information of the terminal, the terminal approaches at least one of a product registered in a purchase product list in the EC store, a product registered in a product wish list in the EC store, and a product browsed by the customer specified on the basis of a browsing history in the EC store, information on any of the products is output to the terminal.

### Supplementary Note 6

The output control method according to any one of Supplementary Notes 1 to 5, in which

in the processing of outputting, in a case where the terminal approaches the cashier area or the exit area in the actual store, information regarding at least one product of a product registered in a purchase product list in the EC store, a product registered in a product wish list in the EC store, and a product browsed by the customer specified on the basis of a browsing history in the EC store is output to the terminal.

### Supplementary Note 7

The output control method according to any one of Supplementary Notes 1 to 6, in which

the at least one computer executes processing of

making a payment for a product registered in a purchase product list at the EC store and the actual store.

### Supplementary Note 8

The output control method according to any one of Supplementary Notes 1 to 6, in which

the at least one computer executes processing of outputting, via the terminal, checkout information based on information on products registered in a purchase product list in the EC store and the actual store in a readable manner by a checkout device installed in the actual store.

### Supplementary Note 9

An output control device including:

an acquisition unit for acquiring product identification information for identifying a product in an actual store by an operation of a customer, via a terminal that executes an application program used for product registration in an EC store and the actual store; and

an output unit for outputting, to the terminal, information browsable in the EC store for the product identified by the product identification information when the product identification information is acquired via the terminal.

### Supplementary Note 10

A program for causing at least one computer to execute processing including:

acquiring product identification information for identifying a product in an actual store by an operation of a customer, via a terminal that executes an application program used for product registration in an EC store and the actual store; and

when the product identification information is acquired via the terminal, outputting, to the terminal, information browsable in the EC store for the product identified by the product identification information.

### Supplementary Note 11

A non-transitory recording medium readable by at least one computer, the recording medium recording a program for causing the computer to execute processing including:

acquiring product identification information for identifying a product in an actual store by an operation of a customer, via a terminal that executes an application program used for product registration in an EC store and the actual store; and

when the product identification information is acquired via the terminal, outputting, to the terminal, information browsable in the EC store for the product identified by the product identification information.

Some or all of the configurations described in Supplementary Notes 2 to 8 dependent on Supplementary Note 1 described above can also be dependent on Supplementary Notes 9, 10, and 11 with a dependent relationship similar to that of Supplementary Notes 2 to 8. Furthermore, not only the Supplementary Notes 1, 9, 10, and 11 but also various pieces of hardware, software, various recording means for recording software, and systems can be similarly dependent on some or all of the configurations described as the supplementary notes without departing from the above-described embodiments.

According to the present disclosure, it is possible to improve the customer's purchasing experience.

1. An output control method in which a computer executes processing comprising:
acquiring product identification information for identifying a product in an actual store by an operation of a customer, via a terminal that executes an application program used for product registration in an electronic commerce (EC) store and the actual store; and
when the product identification information is acquired via the terminal, outputting, to the terminal, information browsable in the EC store for the product identified by the product identification information.

2. The output control method according to claim 1, wherein
in the processing of outputting, when the product identification information is acquired, information regarding at least one product of a product registered in a purchase product list in the EC store, a product registered in a product wish list in the EC store, and a product browsed by the customer specified on the basis of a browsing history in the EC store is output to the terminal.

3. The output control method according to claim 2, wherein
in the processing of outputting, in a case where a product similar to the product identified by the product identification information is at least one of a product registered in a purchase product list in the EC store, a product registered in a product wish list in the EC store, and a product browsed by the customer specified on the basis of a browsing history in the EC store, a comparison result between the product identified by the product identification information and the similar product is output to the terminal.

4. The output control method according to claim 3, wherein
in the processing of outputting, the comparison result is output to the terminal before the product identified by the acquired product identification information is registered in the purchase product list in the actual store.

5. The output control method according to claim 1, wherein
in the processing of outputting, in a case where, on the basis of the shelf allocation information in the actual store and the location information of the terminal the terminal approaches at least one of a product registered in a purchase product list in the EC store, a product registered in a product wish list in the EC store, and a product browsed by the customer specified on the basis of a browsing history in the EC store, information on any of the products is output to the terminal.

6. The output control method according to claim 1, wherein
in the processing of outputting, in a case where the terminal approaches the cashier area or the exit area in the actual store, information regarding at least one product of a product registered in a purchase product list in the EC store, a product registered in a product wish list in the EC store, and a product browsed by the customer specified on the basis of a browsing history in the EC store is output to the terminal.

7. The output control method according to claim 1, wherein
the computer executes processing of
making a payment for a product registered in a purchase product list at the EC store and the actual store.

8. The output control method according to claim 1, wherein
the computer executes processing of
outputting, via the terminal, checkout information based on information on products registered in a purchase product list in the EC store and the actual store in a readable manner by a checkout device installed in the actual store.

9. An output control device comprising:
at least one memory configured to store instructions; and
at least one processor configured to execute the instructions to:
acquire product identification information for identifying a product in an actual store by an operation of a customer, via a terminal that executes an application program used for product registration in an EC store and the actual store; and
output, to the terminal, information browsable in the EC store for the product identified by the product identification information when the product identification information is acquired via the terminal.

10. A non-transitory recording medium readable by a computer, the recording medium recording a program for causing the computer to execute processing comprising:
acquiring product identification information for identifying a product in an actual store by an operation of a customer, via a terminal that executes an application program used for product registration in an EC store and the actual store; and
when the product identification information is acquired via the terminal, outputting, to the terminal, information browsable in the EC store for the product identified by the product identification information.
